(19) United States
(12) Patent Application Publication
(10) Pub. No.: US 2018/0208069 A1
(43) Pub. Date: Jul. 26, 2018

(54) BATTERY EXCHANGE SYSTEM AND BATTERY EXCHANGE METHOD

(71) Applicant: WEN-TE LIN, TAOYUAN CITY (TW)

(72) Inventor: WEN-TE LIN, TAOYUAN CITY (TW)

(21) Appl. No.: 15/651,048

(22) Filed: Jul. 17, 2017

(30) Foreign Application Priority Data
Jan. 25, 2017 (TW) 106102913

(51) Int. Cl. B60L 11/18; B60S 5/06

(52) U.S. Cl. CPC B60L 11/1822; B60L 11/1824; B60K 2001/0455; B60S 5/06; B60L 11/1846; B60L 11/1825

(57) ABSTRACT

A battery exchange system and a battery exchange method are provided. The battery exchange system includes a plurality of battery exchange stations, a central control station and a handheld electronic device. Each battery exchange station includes a battery exchange device. The battery exchange device includes a battery carrier module. The battery carrier module includes a cabinet and at least one battery storage case disposed in the cabinet. The battery storage case has a storage space for accommodating a fully-charged battery. The fully-charged battery provides a second battery-location information and a battery in-stock information through the corresponding battery exchange station. Accordingly, the battery exchange device transmits the second battery-location information and the battery in-stock information of the fully-charged battery to the central control station, and the handheld electronic device receives a second battery-available information that includes the second battery-location information and the battery in-stock information from the central control station.

### BACKGROUND OF THE INVENTION

### 1. Field of the Invention

The present disclosure relates to a battery exchange system and a battery exchange method; more particularly, to a battery exchange system and battery exchange method applicable to electric vehicles.

### 2. Description of Related Art

Battery replacement of electric vehicles such as electric cars and golf carts is performed manually or via simple assistive devices. The batteries of electric vehicles can be connected in series or in parallel so as to provide higher power, which can further be applied to other equipment, such as energy storage systems (ESS).

There are a number of issues in conventional electric vehicles that remain to be improved. Taking electric motorcycles as an example, there exist different types of batteries for different kinds of electric motorcycles, and these different types of batteries cannot be standardized into one specification. One reason for this is: an electric motorcycle performs better when using a battery that is fully compatible with itself, which is often the battery manufactured by the same company that manufactures the electric motorcycle. Another reason is that, when battery failures occur, it would be hard to clarify the attribution of responsibility if electric motorcycles of all kinds use the same type of battery. Therefore, it is still required that electric motorcycles of one brand use batteries of the same brand in the prior art, which could cause many problems such as inconvenience in the charging and exchanging of batteries.

Furthermore, since the process of charging batteries takes time, an electric vehicle user has to wait for the charging process to complete before the electric vehicle can start again, which lowers the mobility of electric vehicles and demotivates the public from using electric vehicles. Moreover, when used for long distance trips, electric vehicles are often loaded with extra batteries for fear that the battery may run out during the trip. However, this increases the load of the electric vehicles and the power consumption rate of batteries.

### SUMMARY OF THE INVENTION

Accordingly, the object of the present disclosure is to provide a battery exchange system and a battery exchange method, which facilitate the exchange of batteries and increase the mobility of electric vehicles.

In order to achieve the aforementioned objects, the present disclosure provides a battery exchange system including a plurality of battery exchange stations, a central control station, and a handheld electronic device. Each of the battery exchange stations includes at least one battery exchange device. The at least one battery exchange device includes a battery carrier module and a power supply module. The battery carrier module includes a cabinet and at least one battery cartridge disposed in the cabinet, in which the at least one battery cartridge includes a carrier case having an accommodating space for accommodating a rechargeable battery, which provides a first battery-location information via the battery exchange station at which the rechargeable battery is located. The power supply module provides the rechargeable battery with electricity. The central control station is in signal connection with the plurality of the battery exchange stations, and the handheld electronic device is in signal connection with the central control station. When the rechargeable battery in the at least one exchange device is fully charged, the battery exchange station transmits a battery-fully-charged information and a first battery-location information of the rechargeable battery to the central control station, and the handheld electronic device receives from the central control station a first battery-exchangeable information including the first battery-location information and the battery-fully-charged information of the rechargeable battery.

Another embodiment of the present disclosure provides a battery exchange system including a plurality of battery exchange stations, a central control station and a handheld electronic device. Each of the battery exchange stations includes at least one battery exchange device, which further includes a battery carrier module. The battery carrier module includes a cabinet and at least one battery container disposed in the cabinet, in which the at least one battery container includes a storage space for accommodating a fully-charged battery, which provides a second battery-location information and a battery-available information via the battery exchange station at which the fully-charged battery is located. The power supply module provides the rechargeable battery with electricity. The central control station is in signal connection with the plurality of the battery exchange stations, and the handheld electronic device is in signal connection with the central control station. The battery exchange station transmits the second battery-location information and the battery-available information of the fully-charged battery to the central control station, and the handheld electronic device receives from the central control station a second battery-exchangeable information including the second battery-location information and the battery-available information of the fully-charged battery.

Yet another embodiment of the present disclosure provides a battery exchange method including: providing a plurality of battery exchange stations, each of which includes a battery exchange device; when a rechargeable battery in the at least one battery exchange device is fully-charged, the battery exchange station transmits a first battery-location information and a battery-fully-charged information of the rechargeable battery to a central control station; a handheld electronic device receives from the central control station a first battery-exchangeable information including the first battery-location information and the battery-fully-charged information of the rechargeable battery; and exchanging a to-be-exchanged battery for the fully-charged rechargeable battery according to the first battery-exchangeable information received by the handheld electronic device.

The present disclosure is advantageous in that the battery exchange station of the present disclosure transmits a battery-fully-charged information and a first battery-location information of the rechargeable battery to the central control station, and the handheld electronic device receives a first battery-exchangeable information that includes the battery-fully-charged information and the first battery-location information of the rechargeable battery, thereby facilitating the exchange of batteries and increasing the mobility of electric vehicles.

In order to further the understanding of the present disclosure, the following embodiments are provided along with illustrations to facilitate the disclosure of the present disclosure.

### BRIEF DESCRIPTION OF THE DRAWINGS

FIG. 1 is a function block diagram illustrating a battery exchange system according to a first embodiment of the present disclosure.

FIG. 2 is schematic diagram illustrating a plurality of battery exchange stations allocated separately on a street block.

FIG. 3 is a schematic diagram illustrating one of the battery carrier modules at one of the battery exchange stations of the battery exchange system according to the first embodiment of the present disclosure.

FIG. 4 is an exploded diagram illustrating one of the battery carrier modules at one of the battery exchange stations of the battery exchange system according to the first embodiment of the present disclosure.

FIG. 5 is a schematic diagram illustrating a battery cartridge of the battery exchange system according to the first embodiment of the present disclosure carrying a main rechargeable battery.

FIG. 6 is a schematic diagram illustrating the battery cartridge of the battery exchange system according to the first embodiment of the present disclosure carrying an auxiliary rechargeable battery.

FIG. 7 is a schematic diagram illustrating the battery exchange system according to the first embodiment of the present disclosure in which a height adjustment part is used.

FIG. 8 is a flow chart of the battery exchange method according to the first embodiment of the present disclosure, in which a to-be-charged battery is exchanged for a fully-charged rechargeable battery.

FIG. 9 is a flow chart of the battery exchange method according to the second embodiment of the present disclosure, in which a to-be-exchanged battery is exchanged for a fully-charged battery.

### DETAILED DESCRIPTION OF THE PREFERRED EMBODIMENTS

The aforementioned illustrations and following detailed description are exemplary for the purpose of further explaining the scope of the present disclosure. Other objectives and advantages related to the present disclosure will be illustrated in the following description and appended drawings.

### The First Embodiment

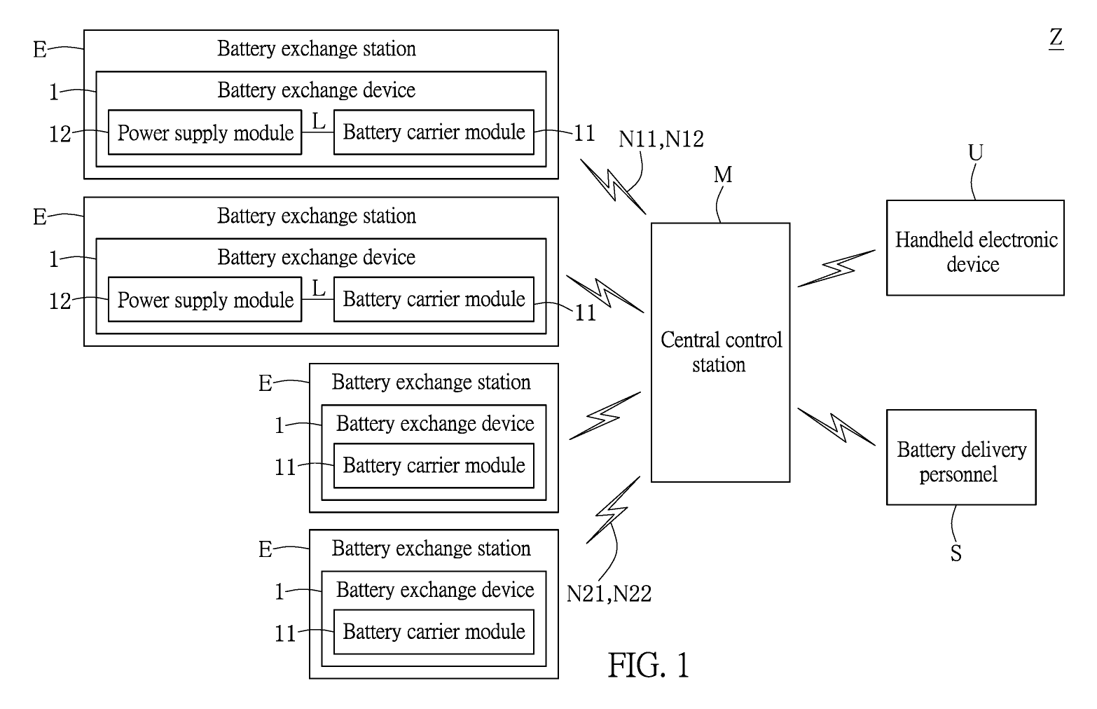

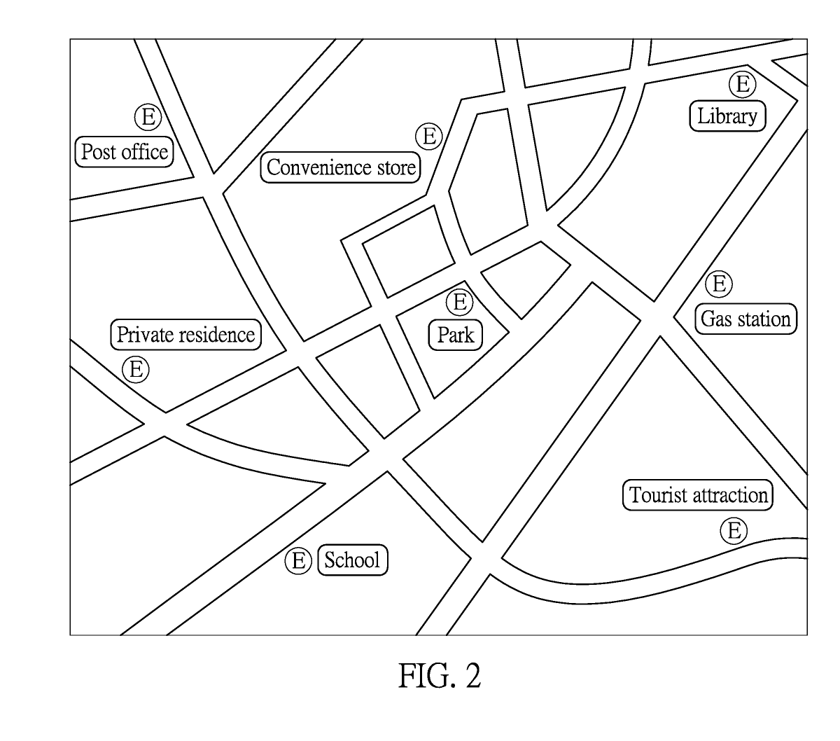

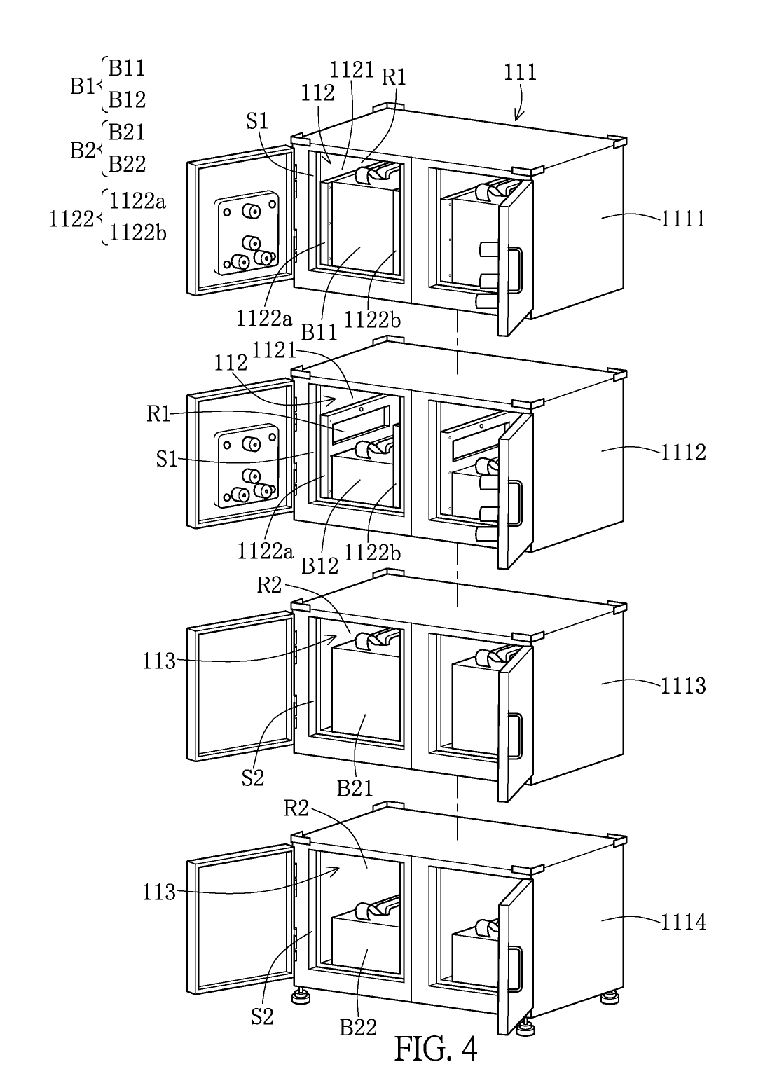

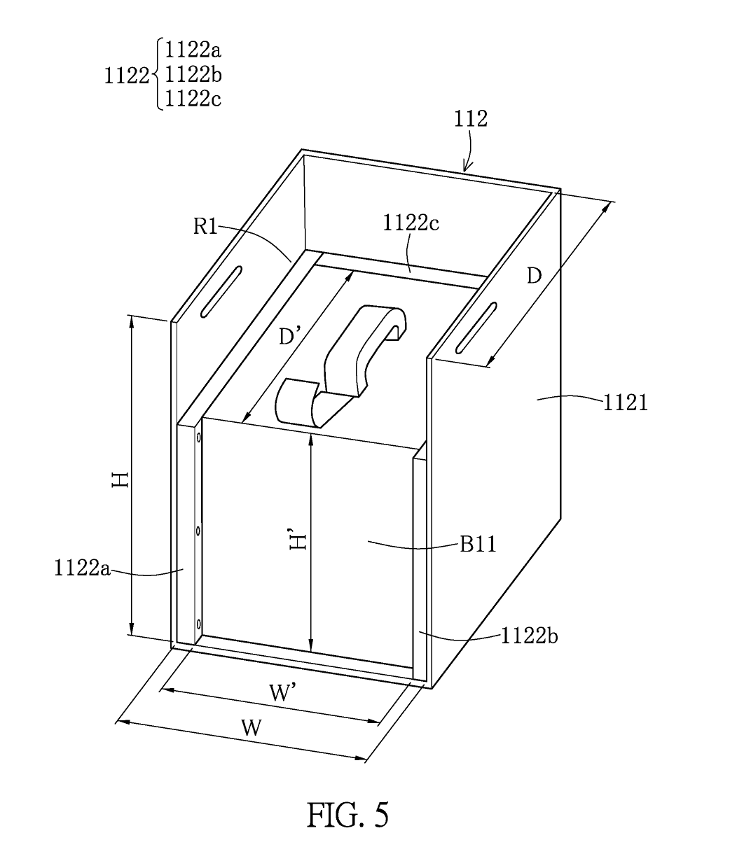

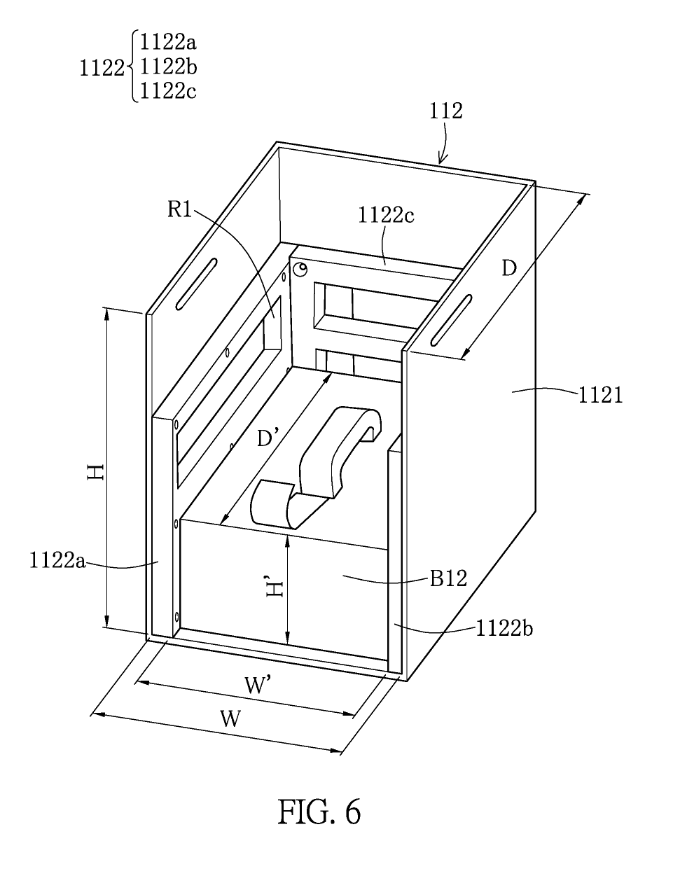

Referring to FIGS. 1 to FIG. 7, the present disclosure provides a battery exchange system Z including a plurality of battery exchange station E, a central control station M, and a handheld electronic device U. The present disclosure is not limited by the number of the battery exchange stations E and the locations of the battery exchange stations E. With reference to FIG. 2, in the present embodiment, the battery exchange system Z includes eight battery exchange stations E, which are installed at places where people often visit, such as gas station, library, post office, park, school, and tourist attractions. The battery exchange station E in FIG. 2 share one or several WiFi networks.

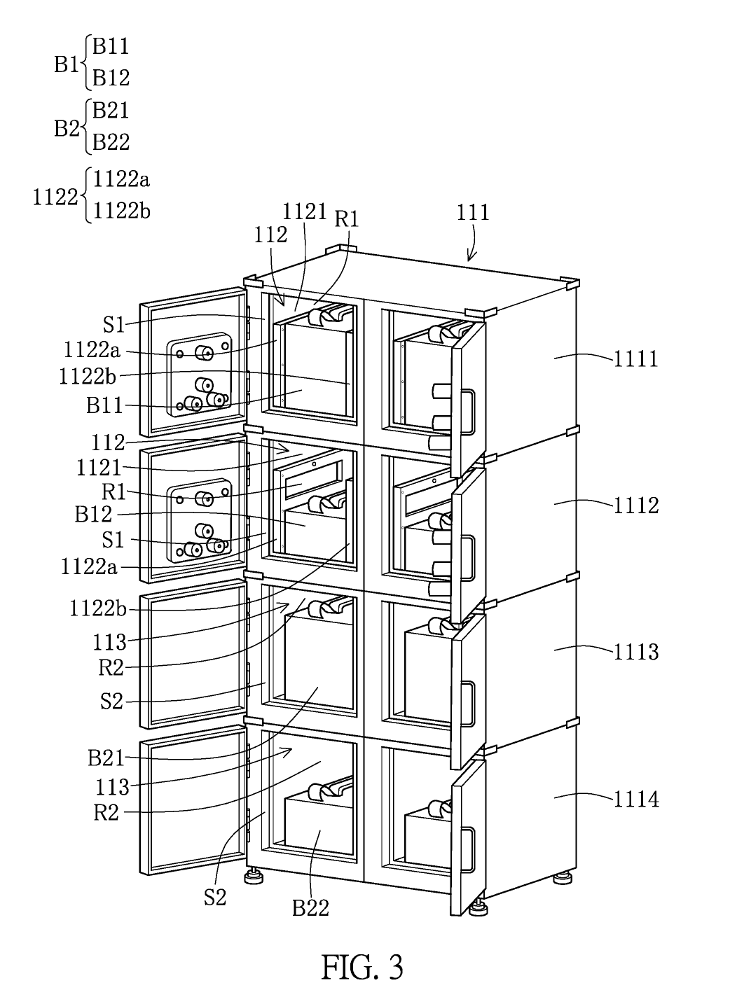

Specifically, each of the plurality of battery exchange stations E includes a battery exchange device 1, which further includes a battery carrier module 11 and a power supply module 12. With reference to FIG. 3, the battery carrier module 11 includes a cabinet 111 and at least one battery cartridge 112 disposed in the cabinet 111. The at least one battery cartridge 112 includes a carrier case 1121 having an accommodating space R1 for accommodating a rechargeable battery B1. The rechargeable battery B1 provides a first battery-location information N11 via the battery exchange station E where the rechargeable battery B1 is located.

More specifically, the rechargeable battery B1 is a main rechargeable battery B11 or an auxiliary rechargeable battery B12. The auxiliary rechargeable battery B12 has an electrical capacity smaller than that of the main rechargeable battery B11 and a size smaller than that of the main rechargeable battery B11. The main rechargeable battery B11 can be an original cell, and the auxiliary rechargeable battery B12 can be a rental cell made by authorized factories. However, the present disclosure is not limited thereto; a rental cell can have an electrical capacity and a size smaller than, equal to, or larger than that of an original cell.

Furthermore, the main rechargeable battery B11, which is made and sold by the electric vehicle manufacturer, can be used individually in electric vehicles as the power source. The auxiliary rechargeable battery B12 is used together with the main rechargeable battery B11 as an alternate source that provides auxiliary electric power. In general, an electric vehicle manufacturer provides the main rechargeable batteries B11 with specifications different from those provided by other manufacturers. A main rechargeable battery B11 is often compatible with only the electric vehicles of the same manufacturer. Moreover, an auxiliary rechargeable battery B12 can be made of different materials and in different shapes; however, every main rechargeable battery B11 and auxiliary rechargeable battery B12 must include a charge portion of the same specification for being connected to a charger. More specifically, a main rechargeable battery B11 includes a charge portion at the bottom or a lateral side thereof, and an auxiliary rechargeable battery B12 includes a charge portion that can be at any part of the surface thereof.

In addition, in the present embodiment, the cabinet 111 is formed of a plurality of unit cabinets 1111, 1112, 1113, 1114. With reference to FIG. 3, the unit cabinets 1111, 1112 each include two battery cartridge accommodating spaces Si for accommodating battery cartridges 112. The battery cartridge 112 can accommodate the main rechargeable battery B11 or the auxiliary rechargeable battery B12. Furthermore, the main rechargeable batteries B11 of different brands, when paired with suitable dismantable assembly 1122, can be compatibly accommodated in the battery cartridge 112. In this embodiment, the battery cartridge 112 of the unit cabinet 1111 carries the main rechargeable batteries B11, and the battery cartridge 112 of the unit cabinet 1112 carries the auxiliary rechargeable battery B12. More specifically, the main rechargeable batteries B11 being carried in the battery cartridge 112 of the unit cabinet 1111 can be of different manufacturers. However, the present disclosure is not limited thereto. For instance, in other embodiments, the cabinet 111 can include a different number of unit cabinets, and the battery cartridge 112 can carry any one of the main rechargeable battery B11 and the auxiliary rechargeable battery B12, and the auxiliary batteries B12 and the main batteries B11 can be of the same or different brands.

Considering that the exchange of an original main rechargeable battery B11 that comes with the electric vehicle for another used one is seldom preferred from the user's perspective, the present disclosure provides the compatibility of the main rechargeable batteries B11 and the auxiliary batteries B12 of different brands in the cabinet 111. With the technical solution described above, an electric vehicle user can exchange his own auxiliary rechargeable battery B12 for another auxiliary rechargeable battery provided in the cabinet.

Furthermore, the first battery-location information contains the information about which battery exchange device the rechargeable battery is located in, and which battery exchange station the battery exchange device belongs to. For example, with reference to FIG. 2, if the battery exchange station E besides the convenience store has three battery exchange devices, the third one of which includes four rechargeable batteries, then any one of the four said rechargeable batteries would provide a first battery-location information N11 that indicates that it is in the third battery exchange device at the battery exchange station besides the convenience store. More specifically, the first battery-location information N11 can indicate the specific carrier case in which the rechargeable is disposed. For example, the first battery-location information provided by the rechargeable battery of the abovementioned four rechargeable batteries that is in the fourth carrier case of the third battery exchange device can show that it is in the fourth carrier case of the third battery exchange device.

Referring to FIG. 1, the power supply module 12 includes at least one power supply wire L electrically connected to the at least one battery cartridge 112 so as to provide the rechargeable battery B1 with electricity. The central control station M is in signal connection with the plurality of battery exchange stations E. The handheld electronic device U is in signal connection with the central control station M. When the rechargeable battery B1 in the at least one exchange device 1 is fully charged, the battery exchange station E transmits a battery-fully-charged information N12 and a first battery-location information N11 of the rechargeable battery B1 to the central control station M, and the handheld electronic device U receives from the central control station M a first battery-exchangeable information including the first battery-location information N11 and the battery-fully-charged information N12 of the rechargeable battery. With the above-described technical solution, when the battery is running low and the exchange of battery is needed, an electric vehicle user can know the location of the nearest rechargeable battery that is available for exchange using the handheld electronic device U.

Moreover, with reference to FIGS. 3 to 7, the battery cartridge 112 includes a dismantable assembly 1122 disposed in the accommodating space R1 of the carrier case 1121. Specifically, the accommodating space R1 is the space enclosed by the carrier case 1121. The dismantable assembly 1122 includes a width adjustment part 1122a, 1122b and a depth adjustment part 1122c. The accommodating space R1 has a maximum width W and a maximum depth D, and the rechargeable battery B1, B2 has a maximum width W′ and a maximum depth D′. Furthermore, the maximum width W and the maximum depth D of the accommodating space R1 are respectively greater than the maximum width W′ and the maximum depth D′ of the rechargeable battery, and one of the width adjustment part 1122a, 1122b and the depth adjustment part 1122c is disposed between the carrier case 1121 and the rechargeable battery B1, B2 so as to maintain the relative position between the rechargeable battery B1 and the carrier case 1121. More specifically, the maximum width W′ of the rechargeable battery B1, B2 plus the width of the width adjustment part 1122a, 1122b is approximately equal to the maximum width of the accommodating space R1 of the carrier case 1121, and the maximum depth D′ of the rechargeable battery B1 plus the depth of the depth adjustment part 1122c is approximately equal to the maximum depth D of the accommodating space R1. Through the structural solution described above, rechargeable batteries B1 of different specifications can be charged in the battery carrier module 11, and thus the integration of batteries with different specifications can be achieved.

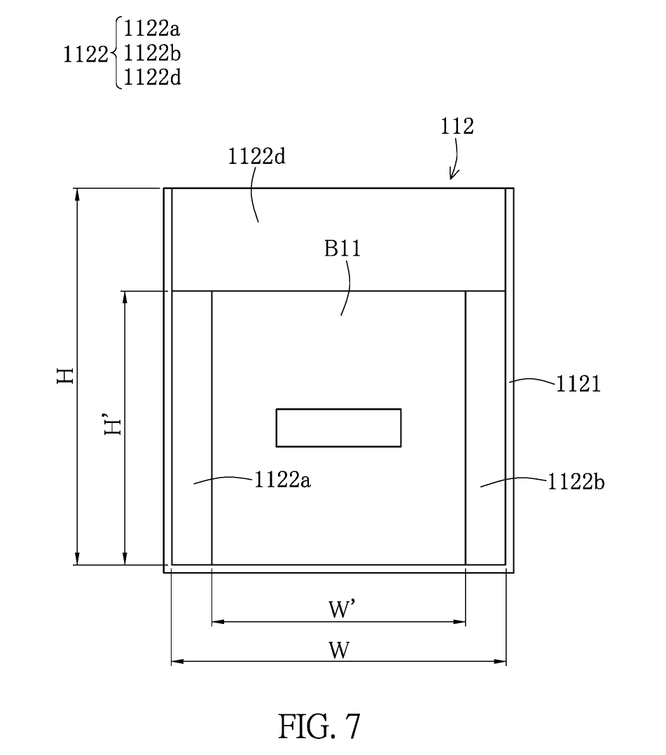

Furthermore, with reference to FIG. 7, the accommodating space R1 has a maximum height, and the main rechargeable battery B11 has a maximum height H′. The dismantable assembly can further include a height adjustment part 1122d. In addition, the maximum height H of the accommodating space R1 is greater than the maximum height H′ of the main rechargeable battery B11, and the height adjustment part 1122d of the dismantable assembly 1122 is disposed between the carrier case 1121 and the main rechargeable battery B11 so as to maintain the relative position between the main rechargeable battery B11 and the carrier case 1121. Specifically, the maximum height H′ of the main rechargeable battery B11 plus the height of the height adjustment part 1122d is approximately equal to the maximum height H of the accommodating space R1. In this way, the main rechargeable battery B11 can be securely positioned in the cabinet 111 and will not shift due to external forces caused by collision, shaking, etc.

With reference to FIGS. 1, 3 and 4, in the present embodiment, the battery carrier module 11 further includes at least one battery container 113 disposed in the cabinet 111. The at least one battery container 113 has a storage space R2 for accommodating a fully-charged battery B2, which provides a second battery-location information N21 and a battery-available information N22 via the battery exchange station E wherein the fully-charged battery B2 is located. The battery exchange station E thereafter transmits a battery-available information N22 and a second battery-location information N21 of the fully-charged battery B2 to the central control station M, and the handheld electronic device U receives from the central control station M a second battery-exchangeable information that includes the battery-available information N22 and the second battery-location information N21 of the fully-charged battery B2.

Referring to FIGS. 1, 3 and 4, one of the differences between the rechargeable battery B1 and the fully-charged battery B2 is: the rechargeable battery B1 is charged within the cabinet 111 and replaced by a to-be-charged battery when the charging is finished, while the fully-charged battery B2 is already fully charged before being disposed in the battery container 113 by a battery delivery personnel S. Specifically, the replacement of the rechargeable battery B1 is done by electric vehicle users, and the fully-charged battery B2 is placed in the battery container 113 by the battery delivery personnel S for rent. More specifically, when a battery container 113 is idle, i.e. not carrying any fully-charged battery B2, the battery exchange station E transmits a battery request information to the battery delivery personnel S, and then the battery delivery personnel S places a fully-charged battery B2 into the idle battery container 113, after which the battery exchange device 1 transmits a battery-available information N22 and a second battery-location information N21 to the central control station M. The handheld electronic device U then receives from the central control station M a second battery-exchangeable information including the second battery-location information N21 and the battery-available information N22. In this way, when the battery is running low and a rental battery is needed, an electric vehicle user can know the location of a nearest fully-charged battery that is available for rent using the handheld electronic device U.

Furthermore, the unit cabinets 1113, 1114 each include two battery container accommodating space S2 for accommodating the battery container 113. The fully-charged battery B2 is a main fully-charged battery B21 or an auxiliary fully-charged battery B22. The auxiliary fully-charged battery B22 has an electrical capacity smaller than that of the main fully-charged battery B21, and a size smaller than that of the main fully-charged battery B21. In the present embodiment, the main fully-charged battery B21 can be a fully-charged full cell, and the auxiliary fully-charged battery B22 can be a fully-charged half-cell. The battery container 113 in the unit cabinet 1113 accommodates main fully-charged batteries B21, and the battery container 113 in the unit cabinet 1114 accommodates auxiliary fully-charged batteries B22. However, the present disclosure is not limited thereto; in other embodiments, the battery container 113 in the unit cabinet 1113 can also be used to accommodate auxiliary fully-charged batteries B22.

In the present embodiment, the cabinet 111 includes four unit cabinets 1111, 1112, 1113, 1114, in which the unit cabinets 1111, 1112 accommodate battery cartridges 112, and the unit cabinets 1113, 1114 accommodate battery containers 113. Furthermore, the battery container 113 in the unit cabinet 1113 is used for accommodating main fully-charged batteries B21, and the battery container 113 in the unit cabinet 1114 is used for accommodating auxiliary fully-charged batteries B22. Nevertheless, the present disclosure is not limited thereto; in other embodiments, the cabinet 111 can include any number of unit cabinets, in which each unit cabinet can have any number of battery cartridge accommodating spaces S1 or battery container accommodating spaces S2, the battery cartridge 112 can be used for accommodating either main rechargeable batteries B11 or auxiliary rechargeable batteries B12, and the battery container 113 can be used for accommodating either main fully-charged batteries B21 or auxiliary fully-charged batteries B22.

In other embodiments, an electric vehicle user can plan an itinerary on a handheld electronic device U that is connected to the central control station M, in which the central control station M can reserve the rechargeable batteries B1 or the fully-charged batteries B2 that are compatible with the user's electric vehicle along the itinerary according to the electrical capacity of the user's own battery, the electricity consumption rate of the user's electric vehicle, and the itinerary. In addition, when the user's own battery is running low, a connection between the user's battery and the handheld electronic device U is automatically established, and the handheld electronic device U transmits a signal to the central control station M in which the signal indicates that the user's battery is running out and a replacement is required. The central control station M then provides the handheld electronic device U with information containing the locations of battery exchange stations E at which rechargeable batteries or fully-charged batteries that are available for exchange or rent. Accordingly, the user can request a reservation with one of the provided battery exchange stations E where the battery exchange is afterwards performed. If the user does not make the reservation, the battery exchange stations E with rechargeable batteries or fully-charged batteries available to be exchanged, sensing that the electric vehicle is in need of a battery exchange, will flash the indicator lamps installed on battery exchange stations E to remind the user that a rechargeable battery or a fully-charged battery is nearby and available. Furthermore, an electric vehicle user can create an account on the central control station M and become a subscriber thereto. Each subscriber is assigned an identification number, and a prepaid account in which deposits can be added to the prepaid account using credit cards. The user can also apply for a token money linked to his/her own account, or save a credit card information under his/her account. The central control station M can deduct deposits from the token money or the prepaid account or charge money from the user's bank through the credit card company. The central control station M can further report on the management information of each rechargeable battery and fully-charged battery to the handheld electronic device. The management information may include the degree of wear and tear, date of production, usage count, etc.

With the above-described technical features, the attribution of responsibility for battery damage would be easy. For example, the battery exchange system Z can be run by battery rental companies, which provide battery cartridges 112, battery containers 113, dismantable assemblies 1122 and other security devices, and the electric vehicle manufacturers, on the other hand, can provide rechargeable batteries B11, fully-charged batteries B12, and the charging equipment compatible with the power supply module 12. When the battery exchange system Z is operated in the above-described manner, electric vehicle users using electric vehicles of different brands can altogether share the service provided by the battery exchange system Z.

### Second Embodiment

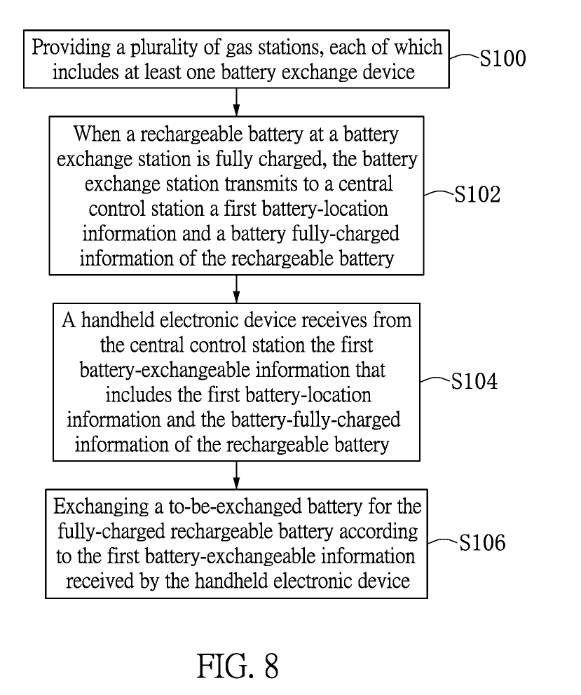

With reference to FIGS. 1, 7 and 8, a battery exchange method according to the second embodiment of the present disclosure includes: a step S100: providing a plurality of battery exchange stations E, each of which includes a battery exchange device 1; a step S102: when a rechargeable battery B1 in the at least one battery exchange device 1 is fully-charged, the battery exchange station E transmits a first battery-location information N11 and a battery-fully-charged information N12 of the rechargeable battery B1 to a central control station M; a step S104: a handheld electronic device U receives from the central control station M a first battery-exchangeable information including the first battery-location information N11 and the battery-fully-charged information N12 of the rechargeable battery B1; a step S106: exchanging a to-be-exchanged battery for the fully-charged rechargeable battery B1 according to the first battery-exchangeable information received by the handheld electronic device U. Through the above-described battery exchange method, an electric vehicle user can use the handheld electronic device U to look up the rechargeable batteries B1 that are nearby and available for exchange, and can thus save the time needed for waiting for the battery to be fully charged, and also dispense with the need for carrying a backup battery. Therefore, the battery exchange method enhances the mobility of electric vehicles.

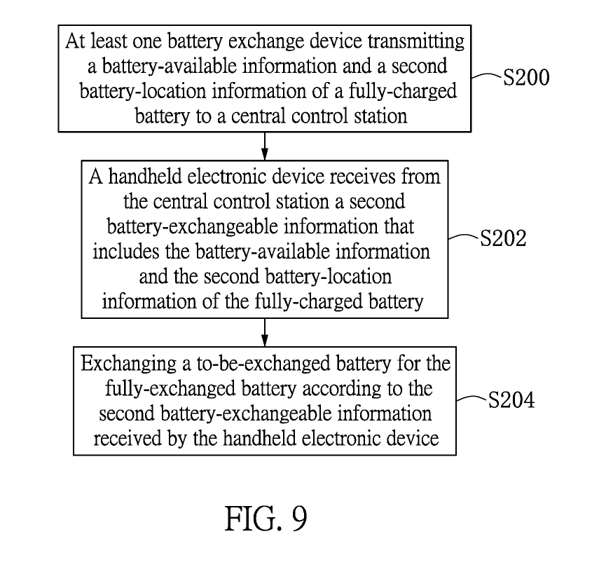

Referring to FIGS. 1 to 7 and 9, the battery exchange method according to the second embodiment of the present disclosure further includes: a step S200: the at least one battery exchange device 1 transmits a battery-available information N22 and a second battery-location information N21 of a fully-charged battery B2 to a central control station M; a step S202: a handheld electronic device U receives from the central control station M a second battery-exchangeable information that includes the battery-available information N22 and the second battery-location information N21 of the fully-charged battery B2; a step S204: exchanging a to-be-exchanged battery for the fully-exchanged battery B2 according to the second battery-exchangeable information received by the handheld electronic device U. With the above-described battery exchange method, an electric vehicle user can rent a fully-charged battery B2 provided by the nearest battery exchange station E.

In summary, the present disclosure is advantageous in that the battery exchange station E of the battery exchange system Z transmits a battery-fully-charged information N12 and a first battery-location information N11 of the rechargeable battery B1 to the central control station M, and the handheld electronic device U receives a first battery-exchangeable information that includes the battery-fully-charged information N12 and the first battery-location information N11 of the rechargeable battery B 1, thereby facilitating the exchange of batteries and increasing the mobility of electric vehicles.

Furthermore, the battery exchange station E of the battery exchange system Z transmits a battery-available information N22 and a second battery-location information N21 of the fully-charged battery B2 to the central control station M, and the handheld electronic device U receives from the central control station M a second battery-exchangeable information including the battery-available information N22 and the second battery-location information N21 of the fully-charged battery B2, by which the present disclosure facilitates the exchange of batteries and increases the mobility of electric vehicles.

The description illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A battery exchange system, comprising:
a plurality of battery exchange stations, each of which includes at least one battery exchange device including:
a battery carrier module including a cabinet and at least one battery cartridge disposed in the cabinet, wherein the at least one battery cartridge includes a carrier case having an accommodating space for accommodating a rechargeable battery, which provides a first battery-location information via the battery exchange station at which the rechargeable battery is located, and
a power supply module providing the rechargeable battery with electricity;
a central control station in signal connection with the plurality of the battery exchange stations; and
a handheld electronic device in signal connection with the central control station,
wherein when the rechargeable battery in the at least one exchange device is fully charged, the battery exchange station transmits a battery-fully-charged information and a first battery-location information of the rechargeable battery to the central control station, and the handheld electronic device receives from the central control station a first battery-exchangeable information including the first battery-location information and the battery-fully-charged information of the rechargeable battery.

2. The battery exchange system according to claim 1, wherein the rechargeable battery is one of a main rechargeable battery and an auxiliary rechargeable battery, in which the auxiliary rechargeable battery has an electrical capacity smaller than that of the main rechargeable battery, and a size smaller than that of the main fully-charged battery.

3. The battery exchange system according to claim 1, wherein the battery cartridge further includes a dismantable assembly disposed in the accommodating space of the carrier case, the dismantable assembly including a width adjustment part and a depth adjustment part, and wherein the accommodating space has a maximum width and a maximum depth, and the rechargeable battery has a predetermined width and a predetermined depth, in which the maximum width and the maximum depth of the accommodating space are respectively greater than the predetermined width and the predetermined depth of the rechargeable battery, one of the width adjustment part and the depth adjustment part being disposed between the carrier case and the rechargeable battery so as to maintain the relative position between the rechargeable battery and the carrier case.

4. The battery exchange system according to claim 3, wherein the accommodating space has a maximum height, and the rechargeable battery has a predetermined height, the maximum height of the accommodating space being greater than the predetermined height of the rechargeable battery, and wherein the dismantable assembly includes a height adjustment part, the height adjustment part of the dismantable assembly being disposed between the carrier case and the rechargeable battery so as to maintain the relative position between the rechargeable battery and the carrier case.

5. The battery exchange system according to claim 1, wherein the battery carrier module further includes at least one battery container disposed in the cabinet, the at least one battery container having a storage space for accommodating a fully-charged battery, which provides a second battery-location information and a battery-available information via the battery exchange station at which the fully-charged battery is located, and wherein the battery exchange station transmits the second battery-location information and the battery-available information of the fully-charged battery to the central control station, and the handheld electronic device receives from the central control station a second battery-exchangeable information including the second battery-location information and the battery-available information of the fully-charged battery.

6. The battery exchange system according to claim 5, wherein the fully-charged battery is one of a main fully-charged battery and a fully-charged auxiliary rechargeable battery, in which the fully-charged auxiliary rechargeable battery has an electrical capacity smaller than that of the main fully-charged battery, and a size smaller than that of the main fully-charged battery.

7. A battery exchange system, comprising:
a plurality of battery exchange stations, each of which includes at least one battery exchange device including:
a battery carrier module including a cabinet and at least one battery container disposed in the cabinet, wherein the at least one battery container includes a storage space for accommodating a fully-charged battery, which provides a second battery-location information and a battery-available information via the battery exchange station at which the fully-charged battery is located;
a central control station in signal connection with the plurality of the battery exchange stations; and
a handheld electronic device in signal connection with the central control station,
wherein the battery exchange station transmits the second battery-location information and the battery-available information of the fully-charged battery to the central control station, and the handheld electronic device receives from the central control station a second battery-exchangeable information including the second battery-location information and the battery-available information of the fully-charged battery.

8. The battery exchange system according to claim 7, wherein the fully-charged battery is one of a main fully-charged battery and an auxiliary fully-charged battery, in which the auxiliary fully-charged battery has an electrical capacity smaller than that of the main fully-charged battery, and a size smaller than that of the main fully-charged battery.

9. A battery exchange method, comprising:
providing a plurality of battery exchange stations, each of which includes a battery exchange device;
when a rechargeable battery in the at least one battery exchange device is fully-charged, the battery exchange station transmits a first battery-location information and a battery-fully-charged information of the rechargeable battery to a central control station;
a handheld electronic device receives from the central control station a first battery-exchangeable information including the first battery-location information and the battery-fully-charged information of the rechargeable battery; and
exchanging a to-be-exchanged battery for the fully-charged rechargeable battery according to the first battery-exchangeable information received by the handheld electronic device.

10. The battery exchange method according to claim 9, further comprising:
the at least one battery exchange device transmits a battery-available information and a second battery-location information of a fully-charged battery to a central control station;
a handheld electronic device receives from the central control station a second battery-exchangeable information that includes the battery-available information and the second battery-location information of the fully-charged battery; and
exchanging a to-be-exchanged battery for the fully-exchanged battery according to the second battery-exchangeable information received by the handheld electronic device.
